(19) United States
(12) Patent Application Publication
(10) Pub. No.: US 2007/0103076 A1
(43) Pub. Date: May 10, 2007

(54) Plasma display panel

(76) Inventors: Ki-Dong Kim, Yongin-si (KR); Yong-Su Park, Yongin-si (KR)

Correspondence Address: CHRISTIE, PARKER & HALE, LLP, PO BOX 7068, PASADENA, CA, 91109-7068, US

(21) Appl. No.: 11/593,692

(22) Filed: Nov. 6, 2006

(30) Foreign Application Priority Data
Nov. 7, 2005 (KR) 10-2005-0106116
Jan. 23, 2006 (KR) 10-2006-0006814

(51) Int. Cl. H01J 17/49

(52) U.S. Cl. 313/582; 313/587; 313/586

(57) ABSTRACT

A plasma display panel (PDP) is provided. The PDP includes first and second substrates positioned generally parallel to each other and separated from each other by a space. A plurality of address electrodes are disposed on the first substrate and a first dielectric layer covers the address electrodes. A plurality of barrier ribs extend from the first dielectric layer and partition the space between the first and second substrates into discharge spaces. A phosphor layer is disposed in the discharge spaces. A plurality of display electrodes are disposed on the second substrate generally perpendicular to the address electrodes. A second dielectric layer is disposed over the display electrodes and a protective layer covers the second dielectric layer. The protective layer includes MgO and Zr and may further include Sn.

### CROSS-REFERENCE TO RELATED APPLICATIONS

This application claims priority to and the benefit of Korean Patent Application Nos. 10-2005-0106116 filed on Nov. 7, 2005 and 10-2006-0006814 filed on Jan. 23, 2006, both applications filed in the Korean Intellectual Property Office, the entire contents of which are incorporated herein by reference.

### BACKGROUND OF THE INVENTION

1. Field of the Invention

The present invention relates to plasma display panels (PDPs). More particularly, the present invention relates to plasma display panel with improved display quality.

2. Description of the Related Art

A plasma display panel (PDP) is a flat display device employing a plasma phenomenon. The plasma phenomenon is also called a gas-discharge phenomenon because a discharge is generated in the panel when a potential greater than a certain level is applied to two electrodes separated from each other under a gas atmosphere in a non-vacuum state.

A plasma display device is a flat display device that employs the gas discharge phenomenon to display an image. The display includes discharge gases filled between two substrates including electrodes positioned perpendicular each other.

Plasma display elements are largely divided into two types: alternating current (AC) types, and direct current (DC) types. Among them, AC PDPs are most widely used.

The AC PDP has a basic structure including two electrodes arranged perpendicular to each other on two substrates that face each other. The space between the electrodes is filled with a discharge gas and partitioned by barrier ribs. A first electrode is coated with a dielectric layer for forming wall charges. A second electrode is positioned opposite the first electrode. A phosphor layer is disposed on the second electrode.

For economy, the electrodes, the barrier ribs, and the dielectric layers are generally formed through a printing process. Such a process forms a thick dielectric layer, resulting in poor formation of the dielectric layer compared to a layer formed by a thin-film process.

The dielectric layer and the electrode under the dielectric layer are damaged by ion sputtering and also by electrons generated from the discharge. Therefore, the life-span of the AC PDP is shortened.

In an attempt to reduce the influence of ion bombardment during discharge and prevent shortening of the AC PDP life-span, a protective layer is disposed on the dielectric layer to a thickness as thin as hundreds of nanometers (nm). In general, the protective layer of the PDP is formed of MgO. The MgO protective layer can extend the life-span of the AC PDP by reducing the discharge voltage and protecting the dielectric layer from being damaged by the sputtering.

The protective layer, however, has difficulty sustaining uniform display quality because the characteristics of the protective layer vary according to film growing conditions, such as heat deposition. The protective layer may have black noise caused by an address discharge delay (i.e., an address miss, which is a phenomenon in which a selected cell that is supposed to emit light does not emit light). Black noise occurs in a specified region. Specifically, it easily occurs in boundaries between light-emitting regions and non-light-emitting regions. An address miss occurs when there is no address discharge or when a scan discharge occurs at low strength.

### SUMMARY OF THE INVENTION

One embodiment of the present invention provides a plasma display panel having improved display quality.

According to one embodiment of the present invention, a plasma display panel (PDP) includes a first substrate and a second substrate positioned substantially parallel to each other and separated from each other by a distance. The PDP further includes a plurality of address electrodes disposed on the first substrate, a first dielectric layer covering the address electrodes on the first substrate, and a plurality of barrier ribs extending from the first dielectric layer to partition the space between the first and second substrates into discharge spaces. A phosphor layer is disposed in the partitioned discharge spaces. A plurality of display electrodes are disposed on the second substrate in a direction generally perpendicular to the address electrodes on the first substrate. A second dielectric layer covers the display electrodes on the second substrate, and a protective layer covers the second dielectric layer. The protective layer includes MgO and Zr.

Zr is present in the protective layer in an amount ranging from about 60 to about 100 ppm based on the total weight of MgO. In one embodiment, for example, Zr is present in an amount ranging from about 65 to about 80 ppm based on the total weight of MgO. In another example, Zr is present in an amount ranging from 70 to about 80 ppm based on the total weight of MgO.

The average Zr content increases from the surface layer contacting the discharge space across the thickness of the protective layer.

One portion of the protective layer has a Zr content equal to or lesser than another portion of the protective layer closer to the dielectric layer.

The protective layer can further include Sn. Sn is included in an amount ranging from about 50 to about 90 ppm based on the total weight of MgO. In one embodiment, for example, Sn is included in an amount ranging from about 70 to about 80 ppm based on the total weight of MgO. The protective layer has a thickness of about 600 nm or greater. In one embodiment, for example, the protective layer has a thickness ranging from about 600 to about 900 nm.

In one embodiment, the protective layer has a transmittance of about 90% or greater.

In one embodiment, the protective layer has a refractive index ranging from about 1.45 to about 1.74 measured at a wavelength of 640 nm.

The protective layer can be formed using chemical vapor deposition (CVD), electron-beam (E-beam) deposition, ion plating or sputtering. According to one embodiment, for example, ion plating is used to form the protective layer.

### BRIEF DESCRIPTION OF THE DRAWINGS

The above features and advantages of the present invention will be better understood by reference to the following detailed description when considered in conjunction with the attached drawings in which:

FIG. 1 is an exploded perspective view of a plasma display panel according to one embodiment of the present invention;

FIG. 2 is a cross-sectional view of the plasma display panel of FIG. 1 taken along line II-II of FIG. 1;

FIG. 3 is an enlarged cross-sectional view of the protective layer shown in FIG. 2;

FIG. 4 is a graph of the secondary electron emission coefficients of the substrates prepared according to Examples 1 and 2, and Comparative Examples 1, 3, and 5;

FIG. 5 is a graph of the discharge delay times of plasma display panels including the substrates prepared according to Examples 1 through 3, and Comparative Examples 1 through 5;

FIG. 6 is a graph of the secondary electron emission coefficients of the substrates prepared according to Example 4 and Comparative Example 6; and

FIG. 7 is a graph of discharge delay times relative to Zr and Sn content.

### DETAILED DESCRIPTION OF THE INVENTION

Exemplary embodiments of the present invention will now be described with reference to the accompanying drawings.

The present invention relates to protective layers for plasma display panels. The protective layer prevents the dielectric layer and the electrodes under the dielectric layer from being damaged by ion bombardment during discharge of a plasma display panel.

According to one embodiment of the present invention, a protective layer includes MgO as a main component, and Zr. The protective layer including Zr imparts improved electron emission properties and display quality. The protective layer including Zr is formed by providing Zr during MgO deposition. This protective layer can prevent black noise caused by address discharge delay (i.e., address miss, which is a phenomenon in which a selected cell that is supposed to emit light does not emit light and which occurs in a certain area, such as a boundary between a light-emitting region and a non-light-emitting region). Zr can also reduce the discharge firing voltage and the sustain voltage.

Zr is included in the protective layer in an amount ranging from about 60 to about 100 ppm based on the total weight of MgO. In one embodiment, for example, Zr is included in an amount ranging from about 65 to about 80 ppm based on the total weight of MgO. In another embodiment, Zr is included in an amount ranging from about 70 to about 80 ppm based on the total weight of MgO. When the Zr content is less than about 60 ppm or greater than about 100 ppm, the secondary electron emission coefficient is reduced, thereby decreasing a secondary electron emission and increasing the discharge delay time.

The average Zr content increases from the surface layer contacting the discharge space across the thickness of the protective layer.

The portion of the protective layer closer to the dielectric layer has a Zr content equal to or greater than the Zr content at other portions of the protective layer.

The protective layer can further include Sn. Sn is included in an amount ranging from about 50 to about 90 ppm based on the total weight of the MgO. In one embodiment, for example, Sn is included in an amount ranging from about 70 to about 80 ppm based on the total weight of MgO. When the Sn content is outside this range, the discharge delay time is more than 250 nsec (a level at which black noise occurs) and response speed is slow, resulting in deterioration of discharge characteristics.

The average Sn content increases from the surface layer contacting the discharge space across the thickness of the protective layer.

The portion of the protective layer closer to the dielectric layer has a Sn content equal to or greater than the Sn content at other portions of the protective layer.

The protective layer can be formed using chemical vapor deposition (CVD), electron-beam (E-beam) deposition, ion-plating or sputtering. According to one embodiment, for example, the protective layer is formed using ion plating.

The Zr or Sn may present in oxide form or elemental form in the MgO protective layer.

Polycrystalline MgO (rather than monocrystalline MgO) prepared by sintering can easily form a solid solution including a specified amount of Zr or Sn.

The protective layer has a thickness of about 600 nm or greater. In one embodiment, for example, the protective layer has a thickness ranging from about 600 to about 900 nm. When the protective layer has a thickness less than about 600 nm, lifespan may be reduced. When the protective layer has a thickness greater than about 900 nm, production efficiency suffers.

The protective layer may have a transmittance of about 90% or greater. When the protective layer has a transmittance lower than about 90%, actual application to a plasma display panel becomes difficult. There is no maximum value for the transmittance, but the transmittance should be greater than about 90%.

The protective layer has a refractive index ranging from about 1.45 to about 1.74 measured at a wavelength of 640 nm.

The protective layer has a columnar crystalline structure where MgO is grown in several directions. Such a protective layer having a columnar crystalline structure improves life-span characteristics as well as electron emission characteristics.

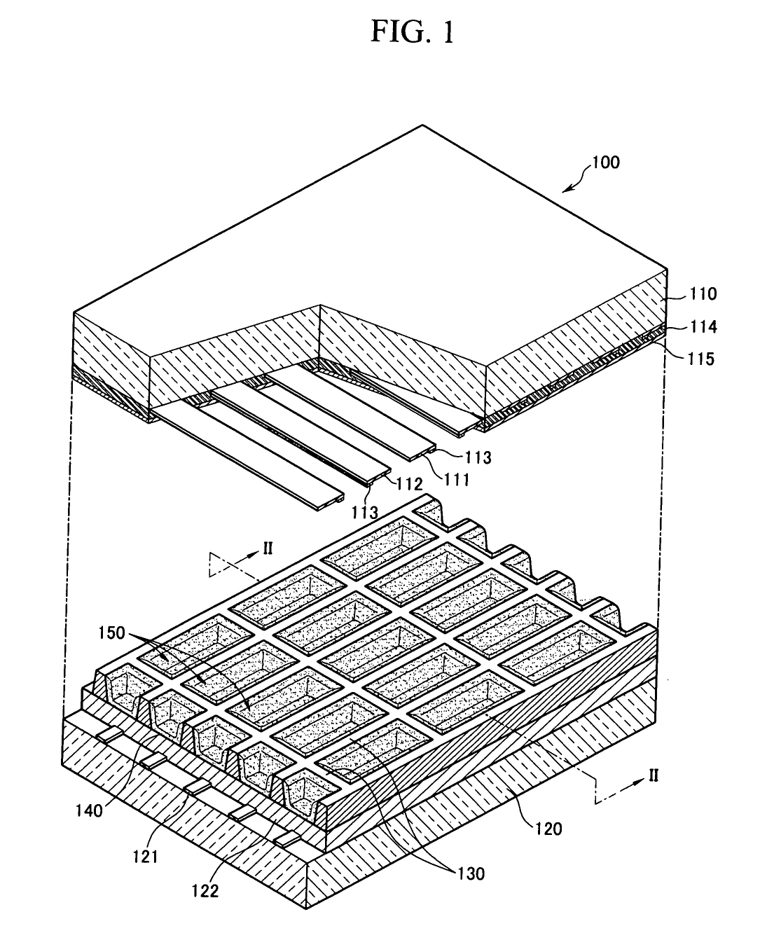

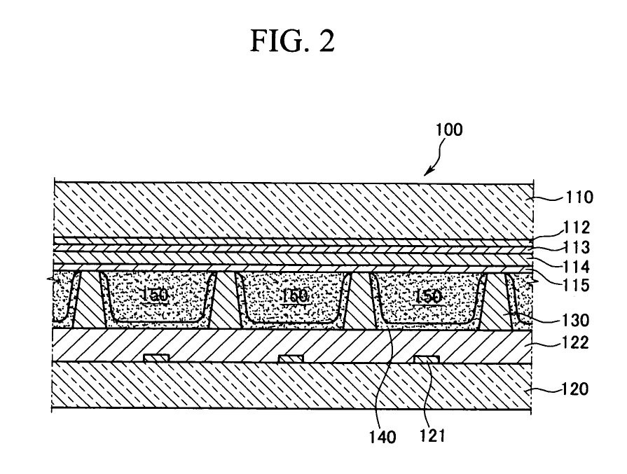

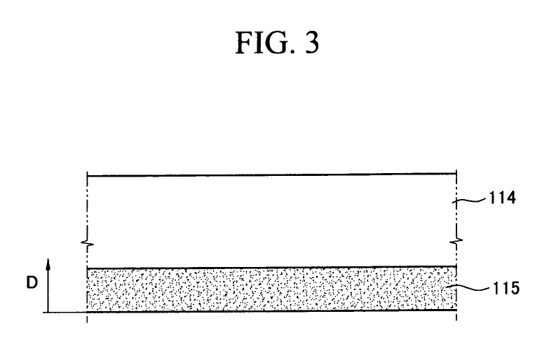

FIG. 1 is an exploded perspective view of a plasma display panel according to one embodiment of the present invention, FIG. 2 is a cross-sectional view of the plasma display panel according to FIG. 1 taken along the line II-II, and FIG. 3 is an enlarged cross-sectional view of the protective layer shown in FIG. 2.

As shown in FIGS. 1 and 2, a plasma display panel 100 according to one embodiment includes a first substrate 110 and a second substrate 120 that are positioned substantially parallel to each other and separated from each other by a distance to create a space between the substrates.

In one embodiment, the first substrate 110 is a transparent substrate and visible light rays generated during discharge transmit through the transparent first substrate 110. However, the first substrate 110 is not limited to a transparent substrate. According to another embodiment, the first substrate may be opaque and the second substrate may be transparent. In yet another embodiment, both the first and second substrates may be opaque. The first and second substrates may be semitransparent, or color filters may be disposed inside the substrates or on surfaces thereof.

On the first substrate 110, first and second discharge electrodes 111 and 112, and bus electrodes 113 are positioned in a striped pattern.

The first discharge electrodes 111 act as scan electrodes, while the second discharge electrodes 112 act as common electrodes. The first and second discharge electrodes 111 and 112 commonly comprise transparent electrodes including Indium Tin Oxide (ITO).

The bus electrodes 113 are disposed beneath the first and second discharge electrodes 111 and 112, and may include metallic materials. The bus electrodes 113 may be narrow to decrease line resistances.

A first dielectric layer 114 is disposed on the first and second discharge electrodes 111 and 112 and the bus electrodes 113. The first dielectric layer 114 prevents the first and second discharge electrodes 111 and 112 from passing an electric current directly between each other during the sustain discharge and also prevents charged particles from crashing directly into and damaging the first and second discharge electrodes 111 and 112. The first dielectric layer 114 thereby guides the charged particles and accumulates wall charges. The dielectric material may include PbO, B₂O₃, SiO₂, or the like.

A protective layer 115 is disposed on the surface of the first dielectric layer 114 and acts to prevent the first and second discharge electrodes 111 and 112 from being damaged by sputtering plasma particles and prevents reductions in discharge voltage by discharging secondary electrons.

Address electrodes 121 are disposed on the second substrate 120. The address electrodes 121 perform address discharge with the first discharge electrodes 111 acting as the scan electrodes.

A second dielectric layer 122 is disposed on the address electrodes 121. The second dielectric layer 122 is formed of the same material as that of the first dielectric layer 114 and serves to protect the address electrodes 121.

According to one embodiment, the first and second discharge electrodes 111 and 112 are positioned in parallel on the first substrate 110. The second substrate 120 may include address electrodes 121. However, a plasma display panel according to one embodiment of the present invention can work with only first and second discharge electrodes 111 and 112, and without address electrodes 121. In this embodiment, the first and second discharge electrodes 111 and 112 are positioned generally perpendicular to each other, so that either of them can simultaneously perform addressing.

Barrier ribs 130 are disposed on the second dielectric layer 122 and serve to maintain a discharge distance and prevent electro-optical cross-talk between discharge cells.

The barrier ribs 130 form discharge spaces with the first and second discharge electrodes 111 and 112 and the address electrodes 121, which discharge spaces are called discharge cells 150. Each discharge cell 150 forms a sub-pixel.

In addition, as shown in FIG. 1, the discharge cells 150 partitioned by the barrier ribs 130 may have a generally rectangular cross-sectional shape, but are not limited thereto and the discharge cells 150 may have any suitable cross-sectional shape, such as a polygonal shape, including triangles, pentagons, and the like. Alternatively, the cross-sectional shape of the discharge cells 150 can be circular, ovular, or the like. In addition, the barrier ribs can be positioned in an open striped pattern.

Red, green, and blue phosphors are coated on the surface of the second dielectric layer 122, forming the bottom of the discharge cells 150. Phosphors are also coated on the sides of the barrier ribs 130 to form phosphor layers 140.

The phosphor layers 140 include components for emitting visible light upon excitation by ultraviolet (UV) light. A red phosphor layer disposed in a red light emitting discharge cell includes a phosphor such as Y(V,P)O₄:Eu or the like. A green phosphor layer in a green light emitting discharge cell includes a phosphor such as Zn₂SiO₄:Mn or the like. A blue phosphor layer disposed in a blue light emitting discharge cell includes a phosphor such as BAM:Eu or the like.

After the first and second substrates 110 and 120 are united and sealed, air in the internal space of the assembled plasma display panel 100 is evacuated and replaced with discharge gas that can enhance discharge efficiency. The discharge gas may include a mixture of gases such as Ne—Xe, He—Xe, He—Ne—Xe, or the like.

According to an exemplary discharge process of a plasma display panel 100 according to one embodiment of the present invention, when an address voltage is applied between the first discharge electrode 111 (acting as a scan electrode) and an address electrode 121 from an outside power source, an address discharge occurs. As a result, a discharge cell where the sustain discharge can occur is selected.

Next, when discharge sustain voltages are applied between the first and second discharge electrodes 111 and 112 of the selected discharge cell, wall charges accumulate near the first and second discharge electrodes 111 and 112 in the first dielectric layer 114 move, thereby causing sustain discharges. The protective layer 115 serves to protect the first dielectric layer 114 and to discharge secondary electrons.

When sustain discharges occur as mentioned above, the discharge gas becomes excited. The excited gas has a lower energy level and discharges ultraviolet (UV) light.

This ultraviolet (UV) light excites the phosphors in the phosphor layer 140 coated on the discharge cell 150. The excited phosphors have lower energy levels and discharge visible light. The discharged visible light is transmitted and radiated, forming an image.

The protective layer 115 of the plasma display panel 100 serves to protect the first dielectric layer 114 and facilitates discharge by discharging secondary electrons.

Hereinafter, the protective layer 115 will be described in more detail. The protective layer 115 includes magnesium oxide (MgO) as a main component, and also includes Zr.

The protective layer 115 may be deposited using any suitable method. Nonlimiting examples of suitable deposition methods include chemical vapor deposition (CVD), electron beam (E-beam) deposition, ion plating, sputtering, and the like. In one embodiment, for example, the protection layer 115 is deposited by ion plating.

The Zr may be included in the protective layer 115 in an amount ranging from about 60 to about 100 ppm based on the total content of magnesium oxide. According to another embodiment of the present invention, the Zr may be included in an amount ranging from about 65 to about 80 ppm based on the total content of MgO. In still another embodiment, the Zr is included in an amount ranging from about 70 to about 80 ppm based on the total content of the MgO.

As described above, the plasma display panel 100 according to one embodiment of the present invention includes the protective layer 115 including Zr, which increases the generation rate of secondary electrons, lowers driving voltages and improves luminous efficiency.

In addition, according to one embodiment of the present embodiment, when the Zr content of the protective layer 115 gradually increases from the surface across the thickness, the amount of discharged secondary electrons increases, and discharge delay time further decreases.

In addition, the Sn may be included in the protective layer in an amount ranging from about 50 to 90 ppm based on the total content of MgO. According to one embodiment of the present invention, for example, the Sn is included in an amount ranging from about 70 to 80 ppm based on the total content of MgO.

As described above, a plasma display panel according to one embodiment of the present invention includes a magnesium oxide protective layer including Zr or Zr and Sn, which increases the amount of discharged secondary electrons and decreases discharge delay time.

When the amount of discharged secondary electrons increases, driving voltage can be lowered, thereby improving luminous efficiency of the plasma display panel. In addition, discharge delay times can be decreased, thereby enabling high-speed addressing and single scan structures, and decreasing scan drive costs.

The following examples illustrate the certain exemplary embodiments of the present invention. It is understood that these examples are provided for illustrative purposes and do not limit the scope of the present invention.

### EXAMPLE 1

A display electrode was fabricated on a surface of a 2.8 mm-thick soda lime glass by screen printing. Then, the display electrode was coated with PbO glass to form a 40 μm-thick dielectric layer. Next, a pellet was prepared by adding 65 ppm of Zr to magnesium oxide (MgO). The pellet was heat-treated at 350° C. and then deposited by ion plating to form a protection layer on the dielectric layer. The protective layer had a thickness of 7000 Å, a transmittance rate of 95%, and a refractive index of 1.65 at 640 nm.

### EXAMPLE 2

An electrode was formed on a 2.8 mm-thick substrate by screen printing and then coated with PbO glass to form a 40 μm-thick dielectric layer. Then, a pellet was prepared by adding 80 ppm of Zr to magnesium oxide (MgO). The pellet was heat-treated at 350° C. and then deposited on the dielectric layer by ion plating to form a protective layer.

### EXAMPLE 3

An electrode was formed on a 2.8 mm-thick substrate by screen printing and then coated with PbO glass to form a 40 μm-thick dielectric layer. Then, a pellet was prepared by adding 100 ppm of Zr to magnesium oxide (MgO). The pellet was heat-treated at 350° C. and deposited on the dielectric layer by ion plating to form a protective layer.

### COMPARATIVE EXAMPLE 1

An electrode was formed on a 2.8 mm-thick substrate by screen printing and then coated with PbO glass to form a 40 μm-thick dielectric layer. Then, a pellet was prepared by adding 100 ppm of Zr to magnesium oxide (MgO). The pellet was heat-treated at 350° C. and then deposited on the dielectric layer by ion plating to form a protective layer.

### COMPARATIVE EXAMPLE 2

An electrode was formed on a 2.8 mm-thick substrate by screen printing and then coated with PbO glass to form a 40 μm-thick dielectric layer. Then, a pellet was prepared by adding 20 ppm of Zr to magnesium oxide (MgO). The pellet was heat-treated at 350° C. and then deposited on the dielectric layer by ion plating to form a protective layer.

### COMPARATIVE EXAMPLE 3

An electrode was formed on a 2.8 mm-thick substrate by screen printing and then coated with PbO glass to form a 120 μm-thick dielectric layer. Then, a pellet was prepared by adding 40 ppm of Zr to magnesium oxide (MgO). The pellet was heat-treated at 350° C. and then deposited on the dielectric layer by ion plating to form a protective layer.

### COMPARATIVE EXAMPLE 4

An electrode was formed on a 2.8 mm-thick substrate by screen printing and then coated with PbO glass to form a 40 μm-thick dielectric layer. Then, a pellet was prepared by adding 50 ppm of Zr to magnesium oxide (MgO). The pellet was heat-treated at 350° C. and then deposited on the dielectric layer by ion plating to form a protective layer.

### COMPARATIVE EXAMPLE 5

An electrode was formed on a 2.8 mm-thick substrate by screen printing and then coated with PbO glass to form a 40 μm-thick dielectric layer. Then, a pellet was prepared by adding 120 ppm of Zr to magnesium oxide (MgO). The pellet was heat-treated at 350° C. and then deposited on the dielectric layer by ion plating to form a protective layer.

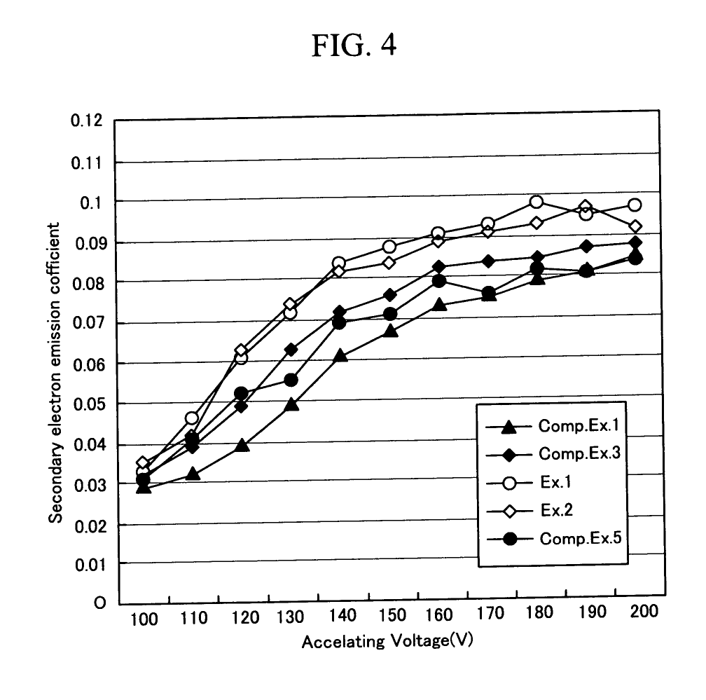

The secondary electron coefficients of the substrates according to Examples 1 to 3 and Comparative Examples 1 to 5 were measured in a plasma environmental measurement chamber. The measurement results of the substrates prepared according to Examples 1 and 2 and Comparative Examples 1, 3, and 5 are provided in FIG. 4.

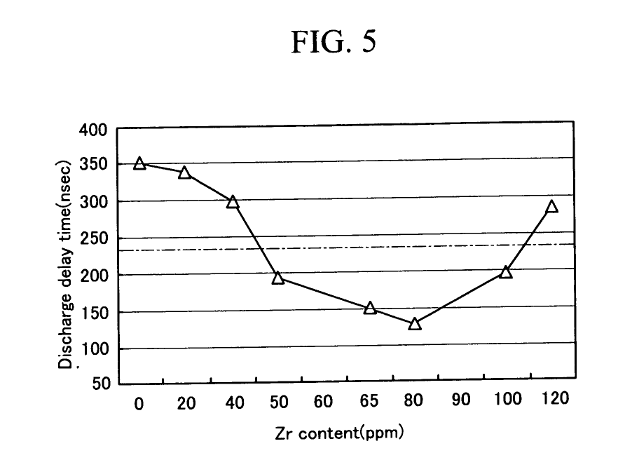

In addition, a plasma display panel including each of the substrates according to Examples 1 through 3 and Comparative Examples 1 through 5 was fabricated and the discharge delay time measured. The results are provided in FIG. 5. The following Table 1 also shows the results of the discharge delay time measurements.

TABLE 1

| | | Comp. | Comp. | | | | | Comp. |
|---|---|---|---|---|---|---|---|---|
| | Comp. Ex. 1 | Ex. 2 | Ex. 3 | Comp. Ex. 4 | Ex. 1 | Ex. 2 | Ex. 3 | Ex. 5 |
| Zr content | 0 | 20 | 40 | 50 | 65 | 80 | 100 | 120 |
| (ppm) | | | | | | | | |
| Discharge | 352 | 338 | 298 | 194 | 152 | 129 | 197 | 285 |
| delay time | | | | | | | | |
| (nsec) | | | | | | | | |

As shown in FIGS. 4 and 5 and Table 1, when the Zr content ranged from 65 to 100 ppm, not only was the secondary electron emission coefficient improved, but also the discharge delay time was reduced.

In other words, referring to FIG. 4, when the accelerating voltage performing the discharge was 180V, the secondary electron emission coefficient was about 0.78 when the Zr content was 0 ppm, about 0.98 when the Zr content was 65 ppm, and about 0.93 when the Zr content was 80 ppm. In addition, the secondary electron emission coefficient became about 0.82 when the Zr content was 120 ppm, which is lower than the coefficients when the Zr content ranged from 65 to 100 ppm.

In addition, referring to FIG. 5 and Table 1, the discharge delay time reference (the point at which a black noise phenomenon occurs, and will occur with increasing discharge delay times) was about 230 nsec (marked with a dotted line in FIG. 5). As shown in FIG. 5, when the amount of Zr included in the protection layer ranged from about 50 to about 100 ppm, the discharge delay time reference had not been reached. As also shown, the discharge delay time was minimized when the amount of Zr ranged from about 65 to about 80 ppm. In particular, when the amount of Zr was 65 ppm, the discharge delay time was 152 nsec, while when the amount of Zr was 80 ppm, the discharge delay time was 129 nsec.

When the amount of Zr increases in the depth (D) direction from the surface of the protective layer 115 across the thickness of the protective layer toward the dielectric layer 114, the secondary electron emission coefficient increases, and the amount of discharged secondary electrons also increases. This phenomenon is illustrated in the secondary electron discharge experiments of Example 4 and Comparative Example 6.

### EXAMPLE 4

An electrode was formed on a 2.8 mm-thick substrate by screen printing and then coated with PbO glass to form a 40 μm-thick dielectric layer. Then, a pellet was prepared with magnesium oxide (MgO), heat-treated at 350° C., and deposited on the dielectric layer by ion plating to form a protective layer. Then, Zr was added to the deposited protective layer by doping. The content of Zr was regulated at different depths from the surface of the protective layer. The respective Zr concentrations and depths are listed in Table 2.

### COMPARATIVE EXAMPLE 6

An electrode was formed on a 2.8 mm-thick substrate by screen printing and then coated with PbO glass to form a 40 μm-thick dielectric layer. Next, a pellet was prepared by adding Zr to magnesium oxide (MgO). Then, the pellet was heat-treated at 350° C. and deposited by ion plating, forming a protective layer on the dielectric layer. The content of Zr was regulated within a range of 74 to 76 ppm, as listed in Table 2.

TABLE 2

| | Depth from the surface of the | | | | | | | |
|---|---|---|---|---|---|---|---|---|
| | protective layer (nm) | | | | | | | |
| | 0 | 100 | 200 | 300 | 400 | 500 | 600 | 700 |
| Zr content of | 79 | 79 | 81 | 83 | 83 | 84 | 84 | 84 |
| Example 4 (ppm) | | | | | | | | |
| Zr content of | 75 | 75 | 76 | 75 | 76 | 74 | 75 | 75 |
| Comparative | | | | | | | | |
| Example 6 (ppm) | | | | | | | | |

The Zr concentrations in Table 2 are based on the total amount of magnesium oxide in the protective layer.

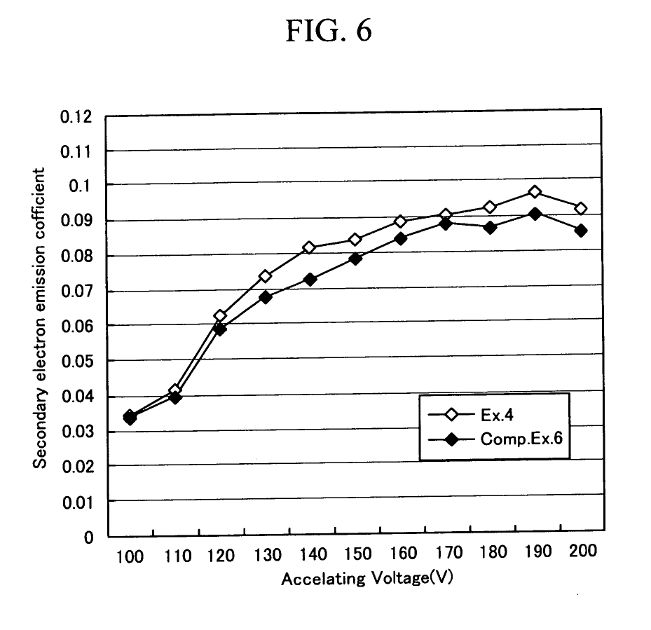

The secondary electron coefficients of the substrates according to Example 4 and Comparative Example 6 were measured in a plasma environmental measurement chamber. The results are provided in FIG. 6.

Referring to FIG. 6, the content of Zr increased in the depth (D) direction from the surface of the protective layer 115 toward the dielectric layer 114, and thereby, the secondary electron emission coefficient also increased. Accordingly, the amount of discharged secondary electrons could be said to increase. In other words, at all accelerating voltages performed in the above experiments, the secondary electron emission coefficient of the substrate of Example 4 was higher than that of Comparative Example 6. Herein, that the content of Zr increases in the depth direction from the surface of the protective layer 115 means not only that the content of Zr continuously increases but also that the average content of Zr increases depending on the total thickness of the protective layer 115.

In other words, the Zr content of Example 4 was 79 ppm at a depth in the protective layer ranging from 0 nm to 100 nm, was 83 ppm at a depth ranging from 300 nm to 400 nm, and was 84 ppm at a depth ranging from 600 nm to 700 nm. With a total thickness of the protective layer ranging from 0 to 700 nm, the average concentration of Zr increased.

The following experimental examples illustrate exemplary embodiments of the protective layer in which Zr and Sn were included.

### EXPERIMENTAL EXAMPLES 1 TO 12

A display electrode was fabricated in a striped pattern on an upper substrate formed of soda lime glass according to a known method using an indium tin oxide conductor material.

Next, a lead-based glass paste was coated over the display electrode on the upper substrate and baked, forming a dielectric layer.

A protective layer including MgO and Zr was disposed on the dielectric layer by sputtering, thereby fabricating an upper panel. The content of Zr added to the MgO was varied as shown in Table 3 below.

### EXPERIMENTAL EXAMPLES 13 TO 24

Display electrodes were fabricated as in Experimental Examples 1 through 12, except that the content of Sn was varied as shown in Table 3.

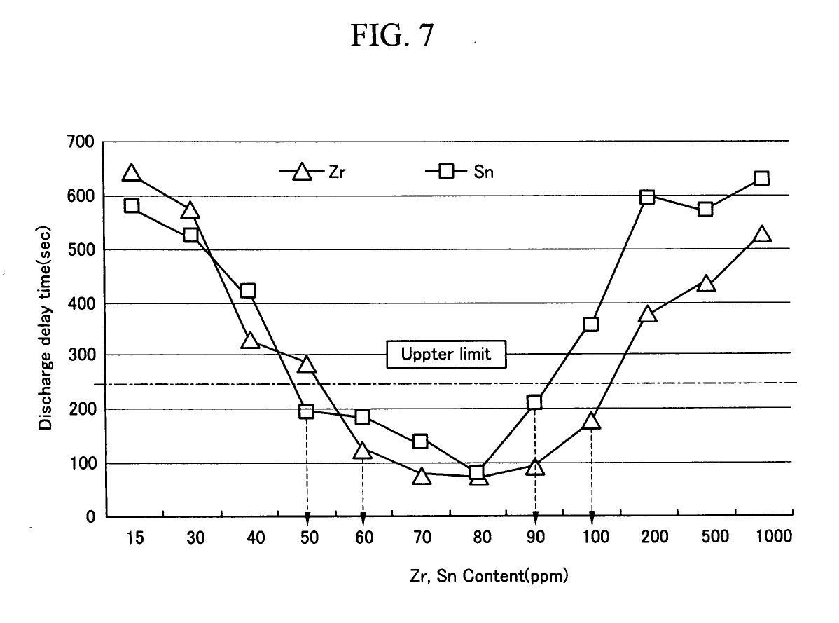

Discharge delay times of Experimental Examples 1 to 24 (dependent on either the Zr or Sn content) were measured, and the results are provided in FIG. 7. The dotted line labeled “upper limit” in FIG. 7 indicates the threshold value above which value black noise will occur.

TABLE 3

| | | | | | | | | | | Exp. | Exp. | Exp. |
|---|---|---|---|---|---|---|---|---|---|---|---|---|
| | Exp. | Exp. | Exp. | Exp. | Exp. | Exp. | Exp. | Exp. | Exp. | Ex. | Ex. | Ex. |
| | Ex. 1 | Ex. 2 | Ex. 3 | Ex. 4 | Ex. 5 | Ex. 6 | Ex. 7 | Ex. 8 | Ex. 9 | 10 | 11 | 12 |
| Zr content | 15 | 30 | 40 | 50 | 60 | 70 | 80 | 90 | 100 | 200 | 500 | 1000 |
| (ppm) | | | | | | | | | | | | |
| | Exp. | Exp. | Exp. | Exp. | Exp. | Exp. | Exp. | Exp. | Exp. | Exp. | Exp. | Exp. |
| | Ex. | Ex. | Ex. | Ex. | Ex. | Ex. | Ex. | Ex. | Ex. | Ex. | Ex. | Ex. |
| | 13 | 14 | 15 | 16 | 17 | 18 | 19 | 20 | 21 | 22 | 23 | 24 |
| Sn content | 15 | 30 | 40 | 50 | 60 | 70 | 80 | 90 | 100 | 200 | 500 | 1000 |
| (ppm) | | | | | | | | | | | | |

As shown in FIG. 7, when Zr was added in an amount ranging from 60 to 100 ppm, and Sn was added in an amount ranging from 50 to 90 ppm, the discharge delay time ranged from 80 to 220 nsec, and black noise did not occur. Accordingly, the good results are obtained when the amount of Zr ranges from 60 to 100 ppm, and when the amount of Sn ranges from 50 to 90 ppm.

### EXAMPLE 5

A display electrode was fabricated in a striped pattern on an upper substrate formed of soda lime glass by a known method using an indium tin oxide conductor material.

Next, a lead-based glass paste was coated over the display electrode on the upper substrate and baked, thereby forming a dielectric layer.

A protective layer including MgO, Zr, and Sn was disposed on the dielectric layer by sputtering, thereby fabricating an upper panel. The content of Zr was 60 ppm based on that of MgO, and the content of Sn was 55 ppm. The discharge delay time was 150 nsec. In addition, the protective layer had a thickness of 7000 Å, a transmittance of 95%, and a refractive index of 1.65 at 640 nm.

As described above, the plasma display panels of the present invention can improve electron discharge properties by including Zr in the MgO protective layer, thereby improving display quality.

While certain exemplary embodiment of the present invention have been illustrated and described, it is understood by those of ordinary skill in the art that various modifications and alterations to the described embodiments may be made without departing from the spirit and scope of present invention, as defined in the appended claims.

What is claimed is:

1. A plasma display panel comprising:
first and second substrates positioned generally parallel to each other and separated from each other by a space;
a plurality of barrier ribs extending from the first substrate, the barrier ribs being positioned to partition the space between the first and second substrates into a plurality of discharge spaces;
a plurality of display electrodes disposed on the second substrate;
a dielectric layer covering the display electrodes on the second substrate; and
a protective layer covering the dielectric layer, wherein the protective layer comprises MgO and Zr.

2. The plasma display panel of claim 1, wherein the protective layer further comprises Sn.

3. The plasma display panel of claim 1, wherein the protective layer has a transmittance of about 90% or greater.

4. The plasma display panel of claim 1, wherein the protective layer has a refractive index ranging from about 1.45 to about 1.74 measured at a wavelength of 640 nm.

5. A plasma display panel comprising:
first and second substrates positioned generally parallel to each other and separated from each other by a space;
a plurality of address electrodes disposed on the first substrate;
a first dielectric layer covering the address electrodes on the first substrate;
a plurality of barrier ribs extending from the first dielectric layer, the barrier ribs being positioned to partition the space between the first and second substrates into a plurality of discharge spaces;
a phosphor layer disposed in the discharge spaces;
a plurality of display electrodes disposed on the second substrate, the display electrodes being positioned generally perpendicular to the address electrodes on the first substrate;
a second dielectric layer covering the display electrodes on the second substrate; and
a protective layer covering the second dielectric layer, wherein the protective layer comprises MgO and Zr.

6. The plasma display panel of claim 5, wherein Zr is present in the protective layer in an amount ranging from about 60 to about 100 ppm based on the total weight of MgO.

7. The plasma display panel of claim 6, wherein Zr is present in the protective layer in an amount ranging from about 65 to about 80 ppm based on the total weight of MgO.

8. The plasma display panel of claim 5, wherein the average Zr content of the protective layer increases from a surface of the protective layer contacting the discharge spaces across a thickness of the protective layer.

9. The plasma display panel of claim 8, wherein the Zr content at a portion of the protective layer closer to the second dielectric layer is equal to or greater than another portion of the protective layer.

10. The plasma display panel of claim 5, wherein the protective layer further comprises Sn.

11. The plasma display panel of claim 10, wherein Sn is present in the protective layer in an amount ranging from about 50 to about 90 ppm based on the total weight of MgO.

12. The plasma display panel of claim 11, wherein Sn is present in the protective layer in an amount ranging from about 70 to about 80 ppm based on the total weight of MgO.

13. The plasma display panel of claim 5, wherein the protective layer has a thickness of about 600 nm or greater.

14. The plasma display panel of claim 13, wherein the protective layer has a thickness ranging from about 600 to about 900 nm.

15. The plasma display panel of claim 5, wherein the protective layer has a transmittance of about 90% or greater.

16. The plasma display panel of claim 5, wherein the protective layer has a refractive index ranging from about 1.45 to about 1.74 measured at a wavelength of 640 nm.

17. The plasma display panel of claim 5, wherein the protective layer comprises polycrystalline MgO.

18. The plasma display panel of claim 5, wherein the protective layer is formed using a method selected from the group consisting of chemical vapor deposition (CVD), electron-beam (E-beam) deposition, ion plating and sputtering.

19. The plasma display panel of claim 18, wherein the protective layer is formed by ion plating.
